(19) United States
(12) Patent Application Publication
(10) Pub. No.: US 2009/0201672 A1
(43) Pub. Date: Aug. 13, 2009

(54) Light-emitting clothes

(76) Inventor: Ching-Hui Lee, Guangzhou City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/068,468

(22) Filed: Feb. 7, 2008

(51) Int. Cl. F21V 21/108

(52) U.S. Cl. 362/108

(57) ABSTRACT

The present invention relates to a light-emitting clothes, in which the appearance of the clothes main body is provided with light emitting elements, a water-proof transparent layer being overcoated on the outside of the light emitting elements and the light emitting elements being electrically connected with a power source control box. According to this configuration, the water-proof transparent layer can assuredly prevent the light emitting elements from damage caused by the wetting from water.

### BACKGROUND OF THE INVENTION

1. Field of the Invention

The present invention relates to a light-emitting clothes, particularly to a light-emitting clothes having light emitting elements and a water-proof layer in order provided on the appearance of the clothes main body. According to this configuration, the water-proof transparent layer overcoated on the light emitting elements can assuredly prevent the damage of the light emitting elements cause by the wetting from water.

2. Brief Description of the Prior Art

Life styles of people are deeply affected accompanying with the progress in both industries and commerce of society, the number of night-shift workers such as traffic policemen, dustbin men or road construction workers, or the persons involved in night activities such as a group of friends drinking and chatting in pub or dancing in party so as to release from the pressure of work becomes more and more increased.

Due to fewer people or cars on the road in nighttime than in daytime, drivers in nighttime are inclined to drive faster. This will easily cause a hazardous traffic accident which is easily happened to general people or night-shift workers such as traffic policemen, dustbin men or road construction workers. Especially the light in night is dim, and a traffic accident case occurs easily due to unclear line of view.

Therefore, a design having light reflecting sheets sewn on clothes is proposed such that the light emitted from a car is reflected so as to achieve the effect of reminding the driver of keeping eyes on the pedestrians or night shift workers. However, the utilization of reflection sheets to reflect the light emitted from the car for the reminding of the driver in some cases fails to reach expected effectiveness, such as insufficient light intensity emitted from the car or the person wearing light reflecting clothes positioning in the side corner of the road such that the light came from the car can not irradiate on him. In such cases, an accident is inclined to happen.

In view of the defect occurred on the clothes sewn with reflection sheets, another clothes is proposed in which it is sewn with light emitting diodes (LEDs) directly and the LEDs are connected with a control box having batteries, a circuit board and a switch therein so as to control the light intensity as well as the ON-OFF of the LEDs. According to this configuration, the self-lighting clothes can clearly indicate the location of the clothes wearer even in nighttime or the dim light condition such that the night shift worker or person involved in night activities can be prevented from the danger of collision by a car.

However, the clothes sewn directly with LEDs has defects in usage listed as below:

1. As the LEDs are sewn directly on the appearance of the clothes, the appearance of the clothes is easily damaged.

2. As the LEDs are sewn directly on the appearance of the clothes, LEDs are easily damaged by the wetting from water especially in raining day, so that the clothes sewn with LEDs on the appearance can not be worn in raining day. In this circumstance, traffic policemen, dustbin men and road construction workers who have to carry out their jobs even in rainy day are unable to be fully protected.

In view of the above defects happened in the conventional clothes sewn directly with LEDs, the inventor thus proposes further improvements with respect to the clothes sewn directly with LEDs according to continuous devotion to the product manufacturing and design based on the experience and the knowledge accumulated in the long term involvement of relevant field so as to raise the practical performance the clothes sewn directly with LEDs.

### SUMMARY OF THE INVENTION

This invention relates to a light-emitting clothes, the object of its implementation is to effectively prevent the light emitting elements from being damaged by the wetting of water.

In order to achieve this object, the inventor proposes to provide light emitting elements on the appearance of the clothes main body, a water-proof transparent layer being overcoated on the outside of the light emitting elements and then the light emitting elements being electrically connected with a power source control box.

According to this structure, the water-proof transparent layer can assuredly prevent damage of the light emitting elements cause by the wetting from water such that user can enjoy the pleasure in the dancing party without worrying about the damage of the light-emitting clothes caused by the careless wetting of light emitting elements from wine or water. Additionally, the water-proof transparent layer still enables traffic policemen, dustbin men and road construction workers using the light-emitting clothes of the present invention even in rainy day such that the safety indication effect of the wearer's location can be easily achieved.

Furthermore, the light-emitting clothes is further improved to provide an outer lining between the light emitting elements and the water-proof transparent layer such that the light emitting elements can be attached therewith.

Additionally, the light-emitting clothes is further improved to provide an inner lining between the appearance of the clothes main body and the light emitting elements such that the light emitting elements can be attached therewith.

Moreover, the light-emitting clothes is further improved to provide an inner lining between the appearance of the clothes main body and the light emitting elements, and to provide an outer lining between the light emitting elements and the water-proof transparent layer such that the light emitting elements can be wrapped and combined between the inner lining and the outer lining.

### BRIEF DESCRIPTION OF THE DRAWINGS

The present invention will be better understood by the detailed description of preferred embodiments with reference to the accompanied drawings, in which:

FIG. 1 is a side view of the present invention.

FIG. 2 is a front view of the present invention.

FIG. 3 is an elevation view in details of the power source control box of the present invention.

FIG. 4 is a partial enlarged view of the present invention.

FIG. 5 is a partial enlarged view of the first embodiment of the present invention.

FIG. 6 is a partial enlarged view of the second embodiment of the present invention.

FIG. 7 is a partial enlarged view of the third embodiment of the present invention.

### DETAILED DESCRIPTION OF THE PREFERRED EMBODIMENTS

The technical content, objects and effectiveness of the present invention will become more apparent by the detailed description in conjunction with the accompanying drawings.

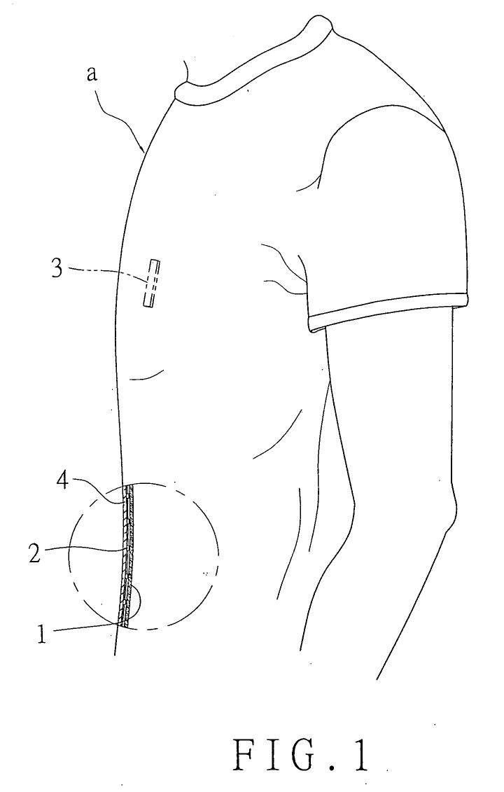

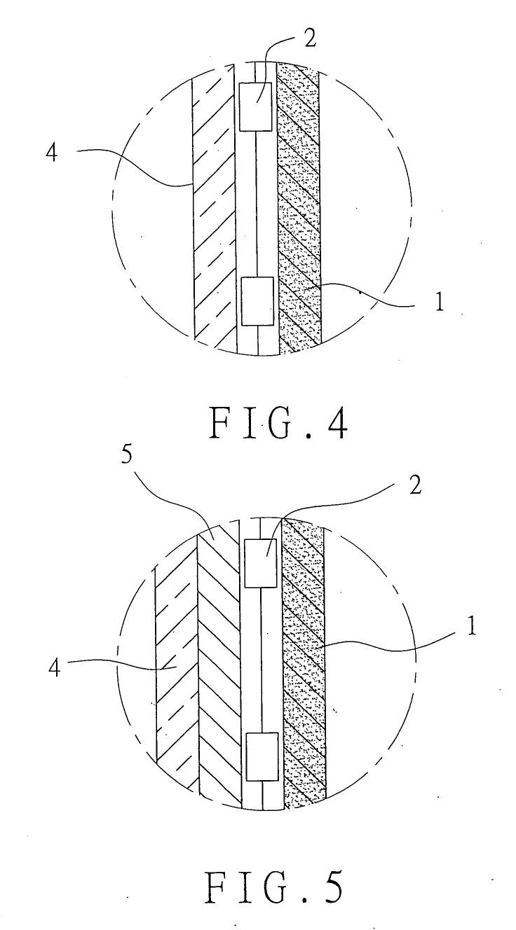

Firstly referring to FIGS. 1 and 4, the light-emitting clothes (a) of the present invention mainly comprises a clothes main body (1), a plurality of light emitting elements (2), a power source control box (3) and a water-proof transparent layer (4), wherein:

the light emitting elements (2) are light emitting diodes [LEDs] or electroluminescent bodies [EL] which are provided on the appearance of the clothes main body (1) and thus can be combined with the appearance of the clothes main body (1) or combined with the inner surface of the water-proof transparent layer (4), and the light emitting elements (2) are electrically connected with the power source control box (3) by lead wires;

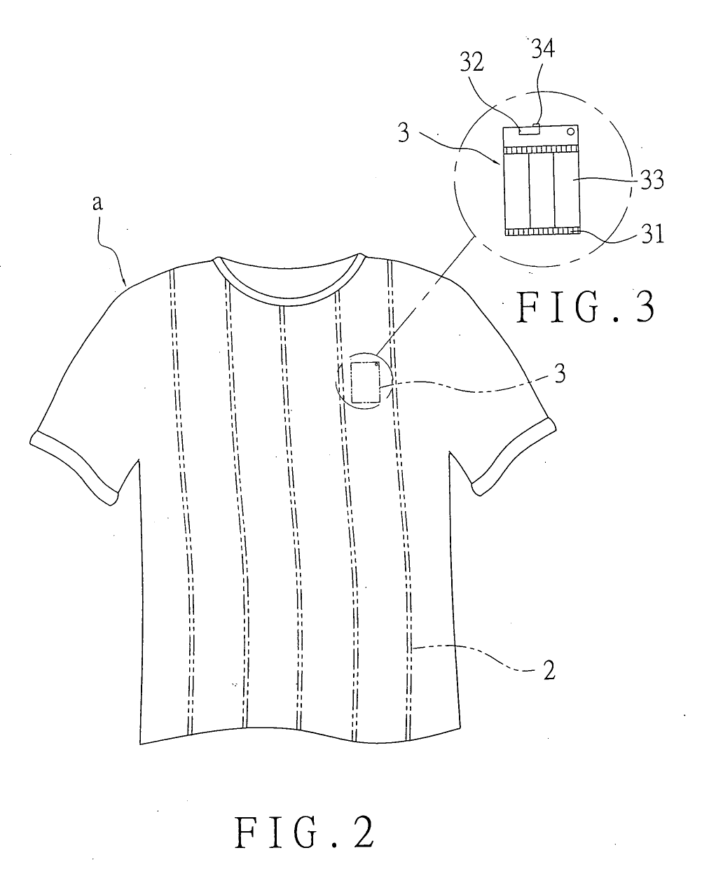

Referring to FIGS. 2 and 3, the power source control box (3) includes a box body (31), a circuit board (32) and batteries (33) provided within the box body (31), and a change-over switch (34) provided outside the box body (31). The power source control box (3) can be provided in the pocket on the inner surface of the clothes main body (1);

the water-proof transparent layer (4) is overcoated on the outside of the light emitting elements (2).

According to this configuration, in order to enhance the safety of the pedestrian walking or working on the road, or the safety of the traffic policemen, dustbin men and road construction workers in nighttime, or in order to enhance the bustling and hustling atmosphere and pleasure feeling of a dancing party, the above-mentioned user wearing the light-emitting clothes (a) of the present invention acts on the change-over switch (34) provided outside the box body (31) to trigger the circuit among the batteries (33), the circuit board (32) and the light emitting elements (2) into the ON state. Then, the light emitting elements (2) provided on the appearance of the clothes main body (1) emit light so as to highlight the unique characteristics of the user in the dancing party, or to enhance the bustling and hustling atmosphere and pleasure feeling. Furthermore, the provision of the water-proof transparent layer (4) enables the user further enjoy the pleasure in the dancing party without worrying about the damage of the light-emitting clothes (a) due to the careless wetting of the light emitting elements (2) from wine or water.

Furthermore, with respect to the pedestrians walking or working on the road or the traffic policemen, dustbin men and road construction workers in nighttime, the location of the above-mentioned personnel wearing the clothes can be clearly indicated by the light intensity emitted from the light emitting elements (2) provided on the light-emitting clothes (a) of the present invention. In this manner, satisfactory alarming effect for a car driver can be attained so as to avoid the clothes wearer such as the pedestrian on the road, or the night shift worker such as the traffic policeman, the dustbin man and the road construction worker from being carelessly collided by the car in nighttime.

Especially in raining, since a water-proof transparent layer (4) is overcoated on the outside of the light emitting elements (2) in the light-emitting clothes (a) of the present invention, the damage caused by wetting of the light emitting elements (2) by rain can be assuredly avoided. Therefore, the light-emitting clothes (a) of the present invention can still emit light in raining so that the user's location is able to be indicated clearly. In this manner, safety protection for the pedestrians walking or working on the road, for the traffic policemen diligently guiding the car on the road, dustbin men and the road construction workers can be effectively provided.

Furthermore, referring to FIG. 5 of the first embodiment of the present invention, the light emitting elements (2), an outer lining (5) and the water-proof transparent layer (4) are provided in this order on the appearance of the clothes main body (1), and the light emitting elements (2) are combined with the outer lining (5). In this manner, the damage on the appearance of the clothes main body (1) caused by the direct combination of the light emitting elements (2) with the appearance of the clothes main body (1) can be avoided.

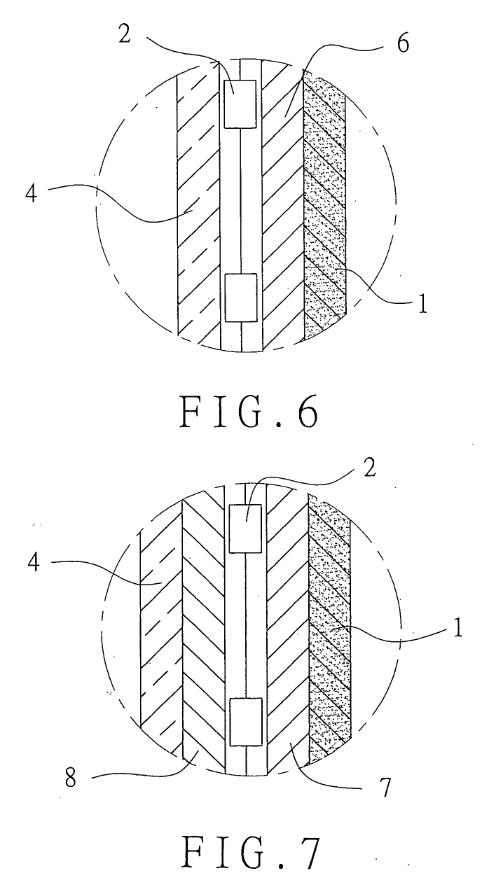

Furthermore, referring to FIG. 6 of the second embodiment of the present invention, an inner lining (6), the light emitting elements (2) and the water-proof transparent layer (4) are provided in this order on the appearance of the clothes main body (1). In this manner, the light emitting elements (2) are combined with the inner lining (6) such that the appearance of the clothes main body (1) can be protected from damage caused by the direct combination of the light emitting elements (2) therewith.

Furthermore, referring to FIG. 7 of the third embodiment of the present invention, an inner lining (7), the light emitting elements (2), an outer lining (8) and the water-proof transparent layer (4) are provided in this order on the appearance of the clothes main body (1). In this manner, the light emitting elements (2) are wrapped and combined between the inner lining (7) and the outer lining (8) such that effective protection for the light emitting elements (2) and exemption of the appearance of the clothes main body (1) from damage caused by the direct combination of the light emitting elements (2) therewith can be achieved.

Based on the foregoing, this invention has the following advantages when comparing with prior art.
1. In the present invention, essentially the light emitting elements, and the water-proof transparent layer overcoated on the outside of the light emitting elements are provided in this order on the appearance of the light-emitting clothes. According to this configuration, the user can enjoy the pleasure in the dancing party as much as he likes without worrying about the damage of the light-emitting clothes caused by the careless wetting of light emitting elements from wine or water.
2. In the present invention, essentially the light emitting elements, and the water-proof transparent layer overcoated on the outside of the light emitting elements are provided in this order on the appearance of the light-emitting clothes such that the damage caused by the wetting of the light emitting elements from the rain can be assuredly avoided. Therefore, the light-emitting clothes can be used even in raining day so that safety protection for the pedestrians walking or working on the road, for the traffic policemen, the dustbin men and the road construction workers in nighttime can be effectively provided.
3. In the present invention, the light emitting elements, the outer lining, and the water-proof transparent layer are provided in this order on the appearance of the light-emitting clothes, and the light emitting elements are combined with the outer lining. In this manner, the damage of the appearance of the clothes main body caused by the direct combination of the light emitting elements therewith can be avoided.
4. In the present invention, the inner lining, the light emitting elements, and the water-proof transparent layer are provided in this order on the appearance of the light-emitting clothes. According to this structure, the light emitting elements can be combined with the inner lining so as to protect the appearance of the clothes from being damaged by the combination with the light emitting elements.
5. In the present invention, the inner lining, the light emitting elements, the outer lining and the water-proof transparent layer are provided in this order on the appearance of the light-emitting clothes. In this manner, the light emitting elements are wrapped and combined between the inner lining and the outer lining such that effective protection for the light emitting elements and exemption of the appearance of the clothes main body from damage caused by the direct combination of the light emitting elements therewith can be achieved.

Summing up above, the embodiments of this invention can reach expected effectiveness, and the specific configurations disclosed herein have yet not seen in the prior art of the same category of product, even has not been opened to the public before application.

Additional advantages and modifications will readily occur to those skilled in the art. Therefore, this invention in its broader aspects is not limited to the specific details and representative embodiment shown and described herein. Accordingly, various modifications and variations may be made without departing from the spirit and scope of the general inventive concept as defined by the appended claims and their equivalents.

What is claimed is:

1. A light-emitting clothes, comprising a clothes main body, light emitting elements, a water-proof transparent layer and a power source control box electrically connected with the light emitting elements, wherein:
said light emitting elements are provided on the appearance of said clothes main body, and said water-proof transparent layer is overcoated on the outside of said light emitting elements.

2. A light-emitting clothes as claimed in claim 1, further comprises an outer lining provided between said light emitting elements and said water-proof transparent layer.

3. A light-emitting clothes as claimed in claim 2, wherein said light emitting elements are combined with said outer lining.

4. A light-emitting clothes as claimed in claim 1, further comprises an inner lining provided between the appearance of said clothes main body and said light emitting elements.

5. A light-emitting clothes as claimed in claim 4, wherein said light emitting elements are combined with said inner lining.

6. A light-emitting clothes as claimed in claim 1, further comprises an inner lining provided between the appearance of said clothes main body and said light emitting elements, and an outer lining provided between said light emitting elements and said water-proof transparent layer.

7. A light-emitting clothes as claimed in claim 6, wherein said light emitting elements are wrapped and combined between said inner lining and said outer lining.

8. A light-emitting clothes as claimed in claim 1, wherein said light emitting elements are combined with the inner surface of said water-proof transparent layer.

9. A light-emitting clothes as claimed in claim 1, where said light emitting elements are combined with the appearance of the clothes main body.

10. A light-emitting clothes as claimed in claim 1, wherein said clothes main body is further provided with a pocket on the inner surface for installing the power source control box inside it.

11. A light-emitting clothes as claimed in claim 1, wherein said power source control box comprises a box body, a circuit board and batteries provided within the box body, and a change-over switch provided outside the box body.

12. A light-emitting clothes as claimed in claim 1, wherein said light emitting elements are light emitting diodes [LEDs].

13. A light-emitting clothes as claimed in claim 1, wherein said light emitting elements are electroluminescent bodies [EL].
